(19) United States
(12) Patent Application Publication
(10) Pub. No.: US 2019/0294826 A1
(43) Pub. Date: Sep. 26, 2019

(54) INFORMATION PROCESSING APPARATUS, INFORMATION PROCESSING SYSTEM, AND INFORMATION PROCESSING METHOD

(71) Applicants: Kabushiki Kaisha Toshiba, Tokyo (JP); Toshiba Electronic Devices & Storage Corporation, Tokyo (JP)

(72) Inventor: Takeshi Obara, Yokohama Kanagawa (JP)

(21) Appl. No.: 16/127,532

(22) Filed: Sep. 11, 2018

(30) Foreign Application Priority Data
Mar. 20, 2018 (JP) 2018-052999

(51) Int. Cl. G06F 21/72; G06F 21/60; G06F 1/30; H04L 9/32; H04L 9/08

(52) U.S. Cl. CPC G06F 21/72; G06F 21/602; H04L 9/0819; H04L 9/3242; G06F 1/30

(57) ABSTRACT

An information processing apparatus has security information management circuitry that manages a plurality of pieces of unencrypted key information in plaintext, and a first controller that instructs the security information management circuitry to encrypt and decrypt data using at least one of the plurality of pieces of key information and performs control to transmit and receive the encrypted data. The security information management circuitry has a volatile first memory that stores first key information for encrypting data to be transmitted and received and second key information for encrypting the first key information, and a nonvolatile second memory that stores third key information for encrypting the first key information and the second key information. The first controller performs control to store, before power supply voltage to the security information management circuitry is cut off, encryption information of the first key information and encryption information of the second key information.

### CROSS REFERENCE TO RELATED APPLICATIONS

This application is based upon and claims the benefit of priority from the prior Japanese Patent Application No. 2018-52999, filed on Mar. 20, 2018, the entire contents of which are incorporated herein by reference.

### FIELD

An embodiment described herein relates to an information processing apparatus that performs encryption processing and decryption processing using key information, an information processing system, and an information processing method.

### BACKGROUND

An in-vehicle information processing apparatus includes a plurality of ECUs (Electronic Control Units), and each ECU mutually transmits and receives various data through a CAN (Controller Area Network). Some data transmitted and received between the plurality of ECUs causes a problem if it is tampered with.

Thus, a MAC (Message Authentication Code), which is tag information for detecting tampering, is added to the data transmitted and received by the ECU. The MAC is generated using a common key information (Key) and any data.

When the common key information Key leaks, any data which has been tampered with can be transmitted to anther ECU. For this reason, it is common to store the common key information Key in a nonvolatile memory such as a flash memory in the security system so that the Key can be handled only within the security system within the ECU.

However, the information processing apparatus requires a separate flash memory that stores a program to be executed by the main processor, and when a plurality of flash memories are provided, the cost increases.

Further, most of the information processing apparatuses can be made into one chip. The microfabrication of the semiconductor process has made the chip smaller, and it is difficult to incorporate the flash memory in the chip.

### BRIEF DESCRIPTION OF THE DRAWINGS

FIG. 1 is a block diagram showing a schematic configuration of an information processing system including an information processing apparatus according to the present embodiment;

FIG. 2 is a block diagram showing an internal configuration of each ECU in FIG. 1;

FIG. 3 is a flowchart showing an example of a Key update procedure;

FIG. 4 is a block diagram of an ECU in which each component and the bus related to the Key update procedure are indicated by a solid line, and each component and the bus having low relevance are indicated by a broken line;

FIG. 5 is a flowchart showing an example of a KEK update procedure;

FIG. 6 is a block diagram of an ECU in which each component and the bus related to the KEK update procedure are indicated by solid lines, and each component and the bus having low relevance are indicated by broken lines;

FIG. 7 is a flowchart showing an example of a processing procedure of an export process;

FIG. 8 is a block diagram of the ECU in which each component and the bus related to the export process are indicated by a solid line, and each component and the bus having low relevance are indicated by a broken line;

FIG. 9 is a flowchart showing an example of a processing procedure of an import process;

FIG. 10 is a flowchart of a modification of the export process in FIG. 7;

FIG. 11 is a flowchart of a modification of the import process in FIG. 9;

FIG. 12 is a flowchart showing an example of a processing procedure of a transmission process of encrypting data and transmitting the data to another ECU; and

FIG. 13 is a block diagram of an ECU in which each component and bus related to the transmission process are indicated by solid lines, and parts and buses which are less relevant are indicated by broken lines.

### DETAILED DESCRIPTION

According to one embodiment, an information processing apparatus has:

security information management circuitry that manages a plurality of pieces of unencrypted key information in plaintext; and

a first controller that instructs the security information management circuitry to encrypt and decrypt data using at least one of the plurality of pieces of key information and performs control to transmit and receive the encrypted data,

wherein the security information management circuitry has

a volatile first memory that stores first key information for encrypting data to be transmitted and received and second key information for encrypting the first key information, and

a nonvolatile second memory that stores third key information for encrypting the first key information and the second key information, and

wherein the first controller performs control to store, before power supply voltage to the security information management circuitry is cut off, encryption information of the first key information encrypted based on the third key information and encryption information of the second key information encrypted based on the third key information in a nonvolatile third memory that is provided separately from the security information management circuitry and the first controller.

Hereinafter, embodiments will be described with reference to the drawings. In this specification and the accompanying drawings, some components are omitted, changed or simplified for ease of understanding and illustration, and are explained and illustrated. Technical details with the extent to which the same function can be expected are also included in and interpreted as the present embodiment. In addition, in the drawings attached to the present specification, for convenience of illustration and ease of understanding, the scales, the aspect ratios in the longitudinal and lateral directions, etc. have been exaggerated by altering the actual ones.

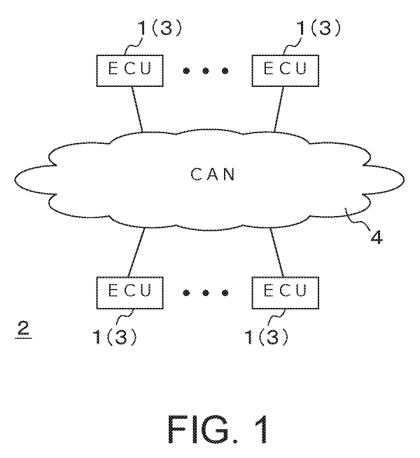

FIG. 1 is a block diagram showing a schematic configuration of an information processing system 2 including an information processing apparatus 1 according to the present embodiment. The information processing system 2 in FIG. 1 is, for example, mounted in a vehicle.

FIG. 1 shows an example in which the information processing apparatus 1 is an ECU 3. The information processing system 2 in FIG. 1 includes a plurality of ECUs 3 and a CAN 4 to which these ECUs 3 are connected in common.

Each ECU 3 is provided in each component of the vehicle, and is capable of mutually transmitting and receiving the encrypted data. Note that the although information processing apparatus 1 and the information processing system 2 in FIG. 1 are not necessarily limited to in-vehicle use, in the following description, the in-vehicle ECU 3 and the information processing system 2 will be described as an example.

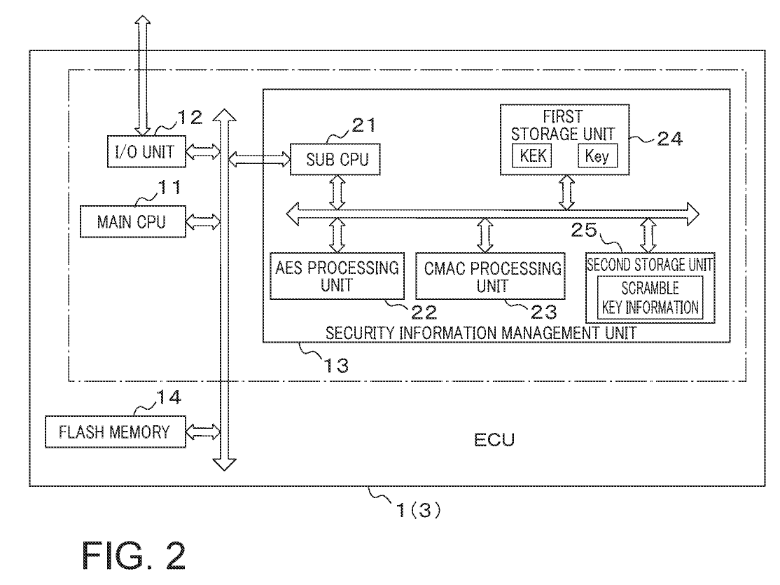

FIG. 2 is a block diagram showing an internal configuration of each ECU 3 in FIG. 1. The ECU 3 in FIG. 1 includes a main CPU (first control unit, first controller) 11, an I/O unit (I/O circuitry) 12, and a security information management unit (security information management circuitry) 13. In addition, a nonvolatile memory composed of a flash memory 14 is externally attached to the ECU 3. The flash memory 14 is originally intended to store programs and the like executed by the main CPU 11. In the present embodiment, the flash memory 14 provided for the main CPU 11 is diverted to store key information to be described later. Therefore, according to the present embodiment, a dedicated flash memory that stores key information is unnecessary, and device cost can be reduced. Each ECU 3 in FIG. 1 can be composed of one semiconductor chip except for the flash memory 14. In FIG. 2, a portion of the ECU 3 excluding the flash memory 14 is represented by a block by a dot-and-dash line.

The main CPU 11 controls each component in the ECU 3. For example, the main CPU 11 instructs the security information management unit 13 to encrypt and decrypt data using at least one of a plurality of pieces of key information, and transmits the encrypted data to and from another ECU 3 via the I/O unit 12 the CAN 4. The main CPU 11 incorporates a work memory such as a cache memory. Note that a memory accessed by the main CPU 11 such as a main memory or a cache memory may be provided separately from the main CPU 11. When the power supply voltage is supplied to the ECU 3, the main CPU 11 reads out and executes a basic program stored in a ROM (not shown), thereafter reads out and executes various programs stored in the flash memory 14.

The security information management unit 13 is also referred to as a security system and manages a plurality of pieces of key information in plaintext and encrypts and decrypts data using at least one of a plurality of pieces of unencrypted key information in accordance with an instruction from the main CPU 11.

In the example of FIG. 2, the main CPU 11, the I/O unit 12, the flash memory 14 and the security information management unit 13 are connected to a common bus. Any bus configurations can be employed.

The security information management unit 13 includes a sub CPU (second control unit, second controller) 21, an AES processing unit (AES processing circuitry) 22, a CMAC processing unit (CMAC processing circuitry) 23, a volatile first storage unit (volatile first memory) 24, and a nonvolatile second storage unit (nonvolatile second memory) 25.

The sub CPU 21 communicates with the main CPU 11 and controls each component in the security information management unit 13 according to an instruction from the main CPU 11. The AES processing unit 22 performs data encryption processing according to AES (Advanced Encryption Standard). The CMAC processing unit 23 performs data encryption processing according to a CMAC (Cipher-based Message Authentication Code) algorithm. Note that the encryption method is not necessarily limited to the AES and the CMAC.

The first storage unit 24 stores a plurality of pieces of key information. The plurality of pieces of key information includes, for example, a common key information (first key information) Key and a key information (second key information) KEK for encrypting the Key. Since the first storage unit 24 may be volatile, and does not require a large memory capacity, it can be constituted by, for example, a register or the like. The register is a volatile memory configured by using, for example, a plurality of flip-flops.

The second storage unit 25 is a nonvolatile memory that stores scramble key information (third key information) for encrypting the Key and the KEK. It is sufficient for the second storage unit 25 to have a small memory capacity capable of storing scramble key information, so that, for example, an eFuse is used for the second storage unit 25. The eFuse can store any logic data according to whether the wiring pattern of the predetermined voltage level is electrically disconnected. Alternatively, the second storage unit 25 can be configured with a logic circuit such as a logic gate. In this case, by fixing the logic of the input terminal of the logic circuit, it is possible to output key information of any logic level from the logic circuit. It is necessary to supply the power supply voltage to the logic circuit used for the second storage unit 25 even when the power supply voltage to the ECU 3 is interrupted. The logic circuit may receive voltage supply from a dedicated battery. Since the security performance is weak when the second storage unit 25 is configured only with the eFuse, scramble key information may be generated by combining the value by the eFuse and the value by the logic circuit.

The security information management unit 13 according to the present embodiment performs management so that the Key and the KEK stored in the first storage unit 24 and the scramble key information stored in the second storage unit 25 cannot be read from the outside of the security information management unit 13.

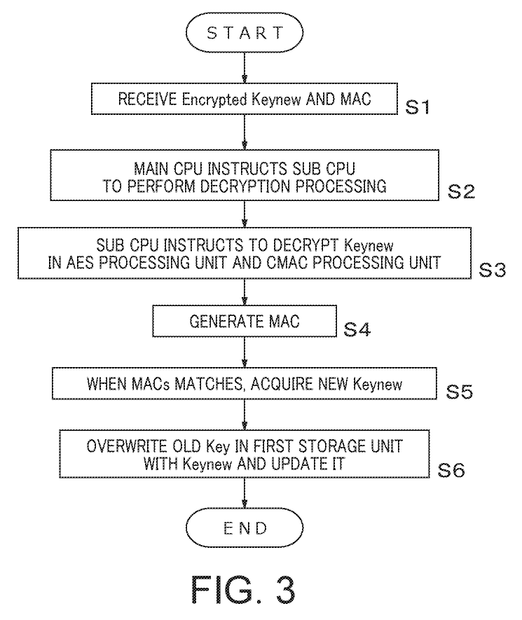

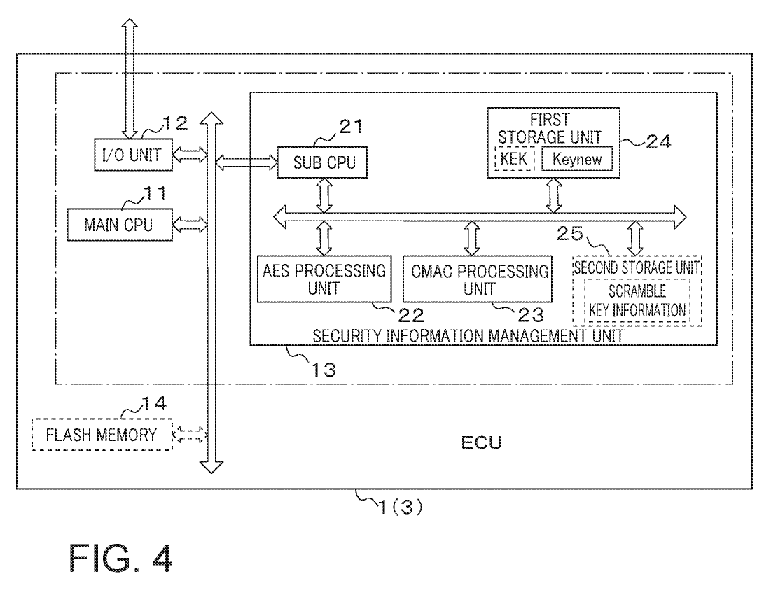

In the initial state immediately after supplying the power supply voltage to the ECU 3, a Keylni and a KEKini, which is information in the initial state, are stored in the first storage unit 24. The Key and the KEK stored in the first storage unit 24 may be updated regularly or irregularly. The timing of updating the Key and the timing of updating the KEK do not necessarily match. FIG. 3 is a flowchart showing an example of a Key update procedure. In addition, FIG. 4 is a block diagram of an ECU 3 in which each component and the bus related to the Key update procedure are indicated by a solid line, and each component and the bus having low relevance are indicated by a broken line.

FIG. 3 shows an example of receiving the encrypted Key from another ECU 3. First, when receiving the encrypted Keynew (Encrypted Keynew) and the MAC via the CAN 4 and the I/O unit 12 (step S1), the main CPU 11 instructs the sub CPU 21 to perform decryption processing (step S2). The encrypted Keynew and the MAC are represented by the following equations (1) and (2), respectively.

Encrypted Keynew=AES(Keynew, KEK) (1)

MAC=CMAC(Encrypted Keynew, KEK) (2)

Upon receiving this instruction, the sub CPU 21 instructs the AES processing unit 22 and the CMAC processing unit 23 to decrypt the new Keynew by using the KEK stored in the first storage unit 24 (step S3). In response to this instruction, the CMAC processing unit 23 generates the MAC based on the above-described equation (2) (step S4), Next, it is determined whether the generated MAC matches with the MAC received at step S1. When they match with each other, the AES processing unit 22 acquires the new Keynew based on the above-described equation (1) (step S5).

When the new Keynew is acquired, the sub CPU 21 overwrites the old Key stored in the first storage unit 24 with the new Keynew and updates the information (step S6).

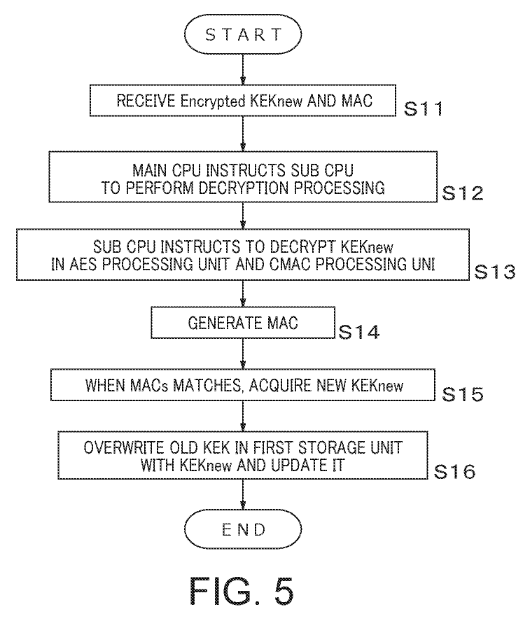

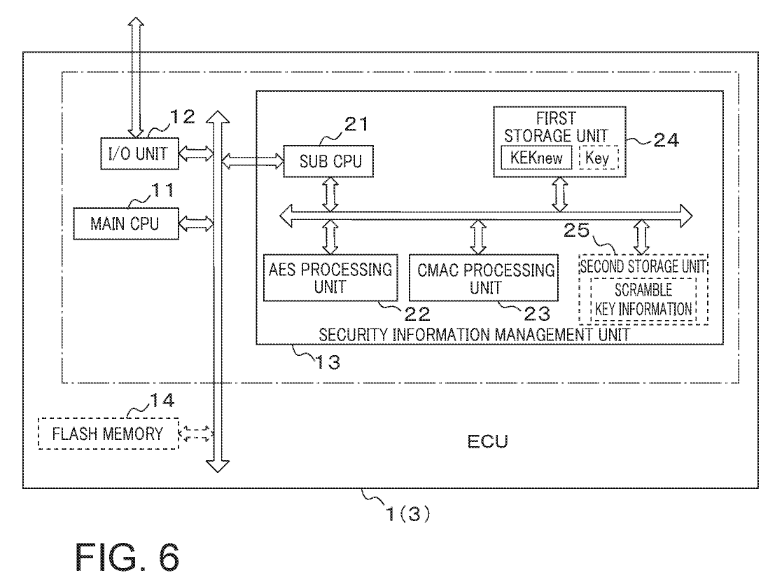

FIG. 5 is a flowchart showing an example of the KEK update procedure. In addition, FIG. 6 is a block diagram of the ECU 3 showing each component and the bus related to the KEK update procedure with a solid line, and each component and the bus having low relevance by a broken line. First, when receiving an encrypted KEKnew(Encrypted keynew) and the MAC via the CAN 4 and the I/O unit 12 (step S11), the main CPU 11 instructs the sub CPU 21 to perform decryption processing (step S12). The encrypted KEK and the MAC are expressed by the following equations (3) and (4), respectively.

Encrypted KEKnew=AES(KEKnew, KEKini) (3)

MAC=CMAC(Encrypted KEKnew, KEKini) (4)

Upon receiving this instruction, the sub CPU 21 instructs the AES processing unit 22 and the CMAC processing unit 23 to decrypt the new KEKnew by using a KEKini stored in the first storage unit 24 (step S13). Upon receipt of this instruction, the CMAC processing unit 23 generates the MAC based on the above-described equation (4) (step S14). Next, it is determined whether the generated MAC matches with the MAC received at step S11. When they match with each other, the AES processing unit 22 acquires the new KEKnew based on the above-described equation (3) (step S15).

When the new KEKnew is acquired, the sub CPU 21 overwrites the KEKini stored in the first storage unit 24 with the new KEKnew and updates the information (step S16).

Since the first storage unit 24 is a volatile memory, when power supply to the security information management unit 13 is cut off, the Key and the KEK in the first storage unit 24 are erased. Therefore, in the present embodiment, before the power supply to the security information management unit 13 is cut off, the Key and the KEK in the first storage unit 24 are encrypted, and then are evacuated in the flash memory 14 provided outside the security information management unit 13. This evacuation process is called the export process in the present embodiment.

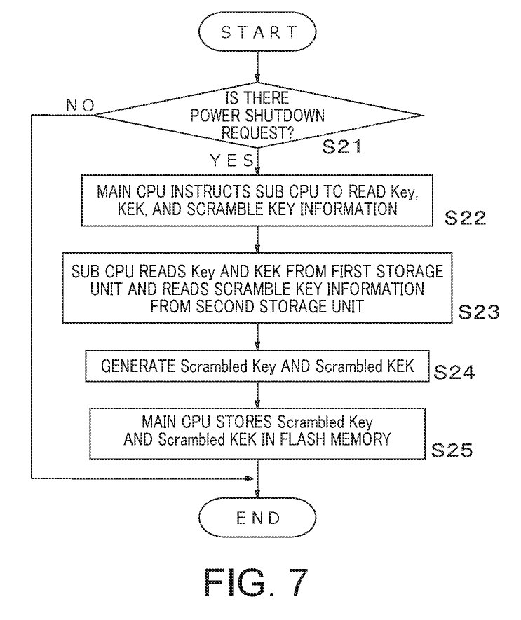

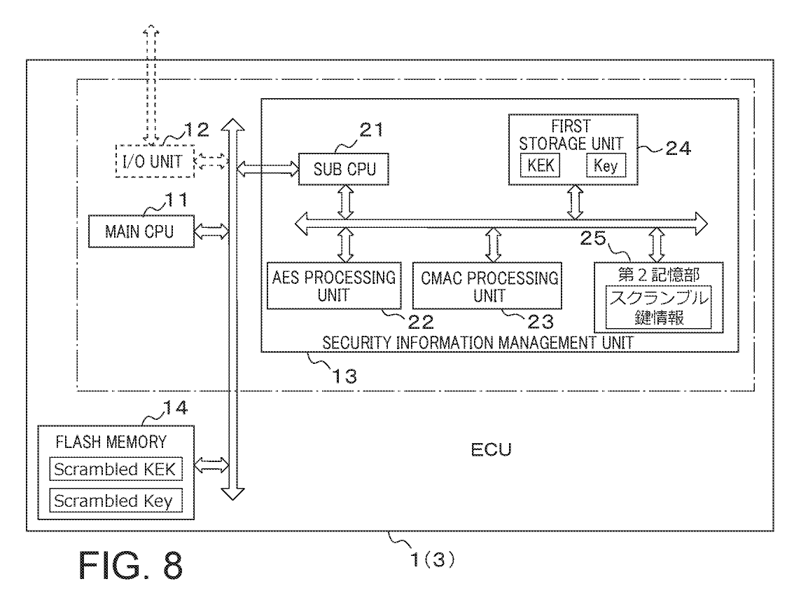

FIG. 7 is a flowchart showing an example of the processing procedure of the export process. FIG. 8 is a block diagram of the ECU 3 in which each component and the bus related to the export process are indicated by a solid line, and each component having low relevance and the bus are indicated by a broken line.

First, the main CPU 11 determines whether there is a power shutdown request to the security information management unit 13 (step S21), When there is no power shutdown request, the processing in FIG. 7 ends.

When there is a power shutdown request, the main CPU 11 instructs the sub CPU 21 to read the Key and the KEK in the first storage unit 24 and to read the scramble key information in the second storage unit 25 (step S22).

Upon receiving this instruction, the sub CPU 21 reads the Key and the KEK from the first storage unit 24 and reads the scramble key information from the second storage unit 25 (step S23).

Next, the sub CPU 21 generates a Scrambled Key obtained by encrypting the Key using the scramble key information and a Scrambled KEK obtained by encrypting the KEK using the scramble key information (step S24). At this time, encryption by the AES processing unit 22 is indispensable. Further, the MAC may be generated by the CMAC processing unit 23.

Next, the main CPU 11 stores the Scrambled Key and the Scrambled KEK generated by the sub CPU 21 in the flash memory 14 (step S25).

As shown in FIG. 7 and FIG. 8, although the Scrambled Key and the Scrambled KEK obtained by encrypting the Key and the KEK, respectively, are output outside the security information management unit 13, the Key, the KEK and the scramble key information are not output outside the security information management unit 13. Therefore, it is difficult to decrypt the Scrambled Key and the Scrambled KEK outside the security information management unit 13, and the security performance can be improved.

When the power supply to the security information management unit 13 is resumed, an import process of storing the Key and the KEK again in the first storage unit 24 in the security information management unit 13 is performed. The import process is a process opposite to the export process described above.

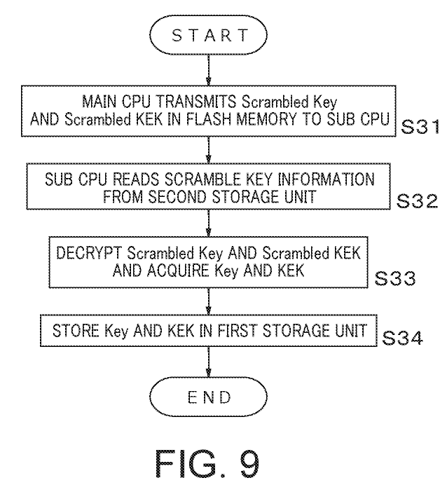

FIG. 9 is a flowchart showing an example of the processing procedure of the import process. Each component and the bus type related to the import process are the same as those in FIG. 8. The process in FIG. 9 is started when power supply to the security information management unit 13 is resumed. First, the main CPU 11 reads the Scrambled Key and the Scrambled KEK in the flash memory 14, transfers them to the sub CPU 21, and instructs the sub CPU 21 to decrypt the Key and the KEK (step S31).

Upon receiving this instruction, the sub CPU 21 reads the scramble key information from the second storage unit 25 (step S32). Then, using the scramble key information, the sub CPU 21 decrypts the Scrambled Key and the Scramble KEK sent from the main CPU 11, and acquires the Key and the KEK (step S33). Thereafter, the sub CPU 21 stores the acquired the Key and the KEK in the first storage unit 24 (step S34).

During the import process in FIG. 9, it may be determined whether the Scrambled Key and the Scrambled KEK are tampered with. In this case, for example, the determination is performed using the MAC.

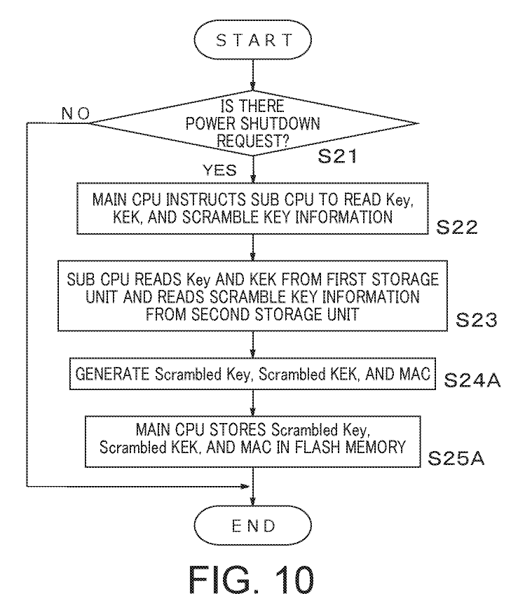

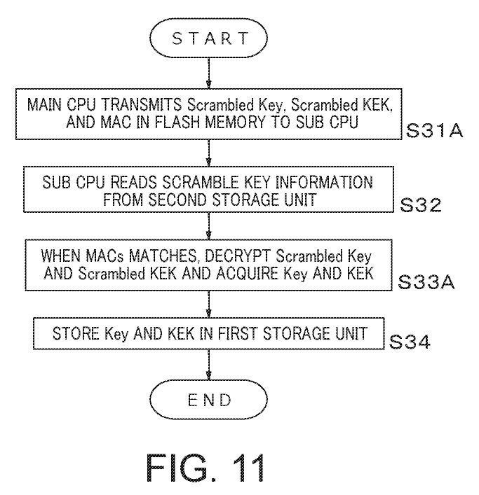

FIG. 10 is a flow chart of a modification of the export process in FIG. 7, and FIG. 11 is a flowchart of a modification of the import process in FIG. 9.

Steps S21 to S23 in FIG. 10 are the same as steps S21 to S23 in FIG. 7. In step S24A, in addition to generating the Scrambled Key and the Scrambled KEK, the MAC (identification information) for the Scrambled Key and the Scrambled KEK is generated using the scramble key information. Next, together with the Scrambled Key and the Scrambled KEK, the generated MAC is stored in the flash memory 14 (step S25A).

In the import process in FIG. 11, the main CPU 11 transmits the Scrambled Key, the Scrambled KEK and the MAC in the flash memory 14 to the sub CPU 21 (step S31A).

Next, the sub CPU 21 reads the scramble key information from the second storage unit 25 (step S32). Next, the sub CPU 21 generates the MAC for the Scrambled Key and the Scrambled KEK received in step S31A using the scramble key information, and determines whether the generated MAC matches with the MAC received in step S31A. When they match with each other, the sub CPU 21 decrypts the received Scrambled Key and the received Scrambled KEK using the scramble key information, and acquires the Key and the KEK (step S33A). Next, the Key and the KEK are stored in the first storage unit 24 (step S34).

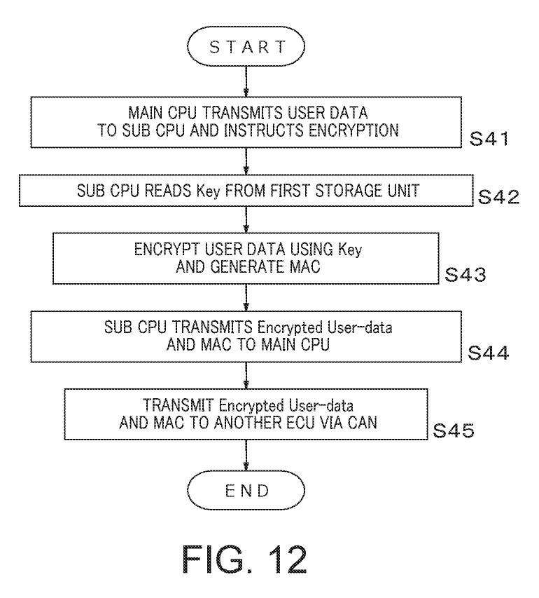

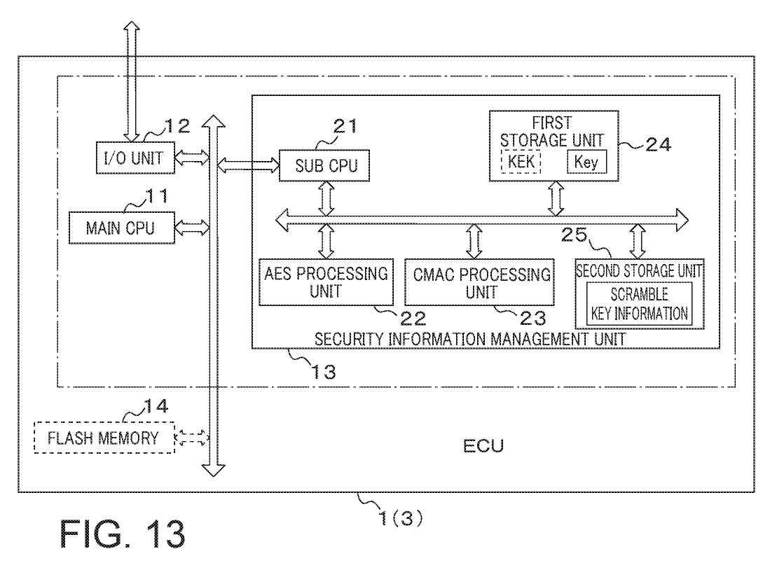

FIG. 12 is a flowchart showing an example of a processing procedure of a transmission process of encrypting data and transmitting it to another ECU 3. FIG. 13 is a block diagram of the ECU 3 in which each component and the bus related to the transmission process are indicated by a solid line, and each component having low relevance and the bus are indicated by a broken line. First, the main CPU 11 transmits the user data to be transmitted to the sub CPU 21 and instructs encryption (step S41). Upon receiving this instruction, the sub CPU 21 reads the Key from the first storage unit 24 (step S42). Next, the sub CPU 21 instructs the AES processing unit 22 to encrypt the user data using the Key, and instructs the CMAC processing unit 23 to generate the MAC of the user data by using the Key (step S43).

The AES processing unit 22 generates Encrypted User-data based on the following equation (5).

In addition, the CMAC processing unit 23 generates the MAC based on the following equation (6).

Encrypted User-data=AES(User-data, Key) (5)

MAC=CMAC(User-data, Key) (6)

The sub CPU 21 transmits the Encrypted User-data generated by the AES processing unit 22 and the MAC generated by the CMAC processing unit 23 to the main CPU 11 (step S44). Upon receiving them, the main CPU 11 transmits the Encrypted User-data and the MAC to another ECU 3 via the I/O unit 12 and the CAN 4 (step S45).

As described above, in the present embodiment, the security information management unit 13 is provided with the volatile first storage unit 24 and the nonvolatile second storage unit 25, the Key and the KEK are stored in the first storage unit 24, and the scramble key information is stored in the second storage unit 25. Then, when cutting off the power supply to the security information management unit 13, the Key and the KEK are encrypted using the scramble key information. The encrypted Key and the encrypted KEK are stored in the flash memory 14 that is outside the security information management unit 13 and stores programs and the like executed by the main CPU 11. Thereafter, when power supply to the security information management unit 13 is resumed, the main CPU 11 reads the encrypted Key and the encrypted KEK in the flash memory 14 and sends them to the security information management unit 13. The sub CPU 21 in the security information management unit 13 decrypts the encrypted Key and the encrypted KEK using the scramble key information in the second storage unit 25 and stores them in the first storage unit 24.

By performing the above processing, even when the power supply to the security information management unit 13 is cut off, the Key and the KEK will not be lost. Further, according to the present embodiment, it is not necessary to provide the security information management unit 13 with the flash memory 14 that stores the key information, and the device cost can be reduced. Furthermore, at the time of cutting off the power of the security information management unit 13, since the encrypted Key and the encrypted KEK is stored in the existing flash memory 14 in which the program executed by the processor and the like are stored, a dedicated nonvolatile memory that stores the encrypted key information is unnecessary, and the device cost can be further reduced.

In the present embodiment, the scramble key information used for encrypting the Key and the KEK at the time of cutting off the power supply to the security information management unit 13 is not output to the outside of the security information management unit 13. As a result, even when the Key and the KEK encrypted using the scramble key information are stored in the flash memory 14 outside the security information management unit 13, the security performance is not reduced. Further, since the Key and the KEK in plaintext stored in the first storage unit 24 are managed so as not to be output to the outside of the security information management unit 13, it is possible to prevent tampering of data and key information and the like.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus comprising:
security information management circuitry that manages a plurality of pieces of unencrypted key information in plaintext; and
a first controller that instructs the security information management circuitry to encrypt and decrypt data using at least one of the plurality of pieces of key information and performs control to transmit and receive the encrypted data,
wherein the security information management circuitry comprises
a volatile first memory that stores first key information for encrypting data to be transmitted and received and second key information for encrypting the first key information, and
a nonvolatile second memory that stores third key information for encrypting the first key information and the second key information, and
wherein the first controller performs control to store, before power supply voltage to the security information management circuitry is cut off, encryption information of the first key information encrypted based on the third key information and encryption information of the second key information encrypted based on the third key information in a nonvolatile third memory that is provided separately from the security information management circuitry and the first controller.

2. The information processing apparatus according to claim 1,
wherein the security information management circuitry includes a second controller that, after a supply of the power supply voltage to the security information management circuitry is resumed, in accordance with an instruction from the first controller, performs control to store the first key information and the second key information in the first memory, the first key information and the second key information being obtained by decrypting, based on the third key information, encryption information of the first key information and encryption information of the second key information stored in the third memory.

3. The information processing apparatus according to claim 2,
wherein the second controller generates, before power supply voltage to the security information management circuitry is cut off, identification information for identifying encryption information of the first key information and encryption information of the second key information based on the third key information,
wherein the first controller performs control to store in the third memory the generated identification information together with encryption information of the first key information and encryption information of the second key information, and
wherein the second controller generates, after a supply of the power supply voltage to the security information management circuitry is resumed, based on the third key information, identification information for identifying the encryption information of the first key information and the encryption information of the second key information stored in the third memory, determines whether the generated identification information matches with the identification information stored in the third memory, and, when the two identification information matches, performs control to store the first key information and the second key information in the first memory, the first key information and the second key information being obtained by decrypting, based on the third key information, encryption information of the first key information and encryption information of the second key information stored in the third memory.

4. The information processing apparatus according to claim 3,
wherein after encrypting data based on the first key information, the second controller transmits the encrypted data and the identification information to the first controller, and
wherein the first controller transmits the encrypted data and the identification information to another information processing apparatus via a network,

5. The information processing apparatus according to claim 1,
wherein the security information management circuitry manages the first to the third key information so that the first key information and the second key information stored in the first memory and the third key information stored in the second memory is not output to an outside of the security information management circuitry.

6. The information processing apparatus according to claim 1,
wherein the third memory is mounted in a nonvolatile memory device that is separated from a semiconductor device in which the security information management circuitry and the first controller are mounted, and
wherein, in addition to storing encryption information of the first key information and encryption information of the second key information, the nonvolatile memory device stores a program to be executed by the first controller.

7. The information processing apparatus according to claim 1,
wherein The second memory stores the third key information based on at least one of an electrical fuse and a fixing of a logic of an input terminal of a logic circuit.

8. An information processing system comprising:
an information processing apparatus; and
a non-volatile memory device,
wherein the information processing apparatus comprises
security information management circuitry that manages a plurality of pieces of unencrypted key information in plaintext; and
a first controller that instructs the security information management circuitry to encrypt and decrypt data using at least one of the plurality of pieces of key information and performs control to transmit and receive the encrypted data,
wherein the security information management circuitry comprises
a volatile first memory that stores first key information for encrypting data to be transmitted and received and second key information for encrypting the first key information, and
a nonvolatile second memory that stores third key information for encrypting the first key information and the second key information, and
wherein the first controller performs control to store, before power supply voltage to the security information management circuitry is cut off, encryption information of the first key information encrypted based on the third key information and encryption information of the second key information encrypted based on the third key information in a nonvolatile third memory that is provided separately from the security information management circuitry and the first controller.

9. The information processing system according to claim 8,
wherein the security information management circuitry includes a second controller that, after a supply of the power supply voltage to the security information management circuitry is resumed, in accordance with an instruction from the first controller, performs control to store the first key information and the second key information in the first memory, the first key information and the second key information being obtained by decrypting, based on the third key information, encryption information of the first key information and encryption information of the second key information stored in the third memory.

10. The information processing system according to claim 9,
wherein the second controller generates, before power supply voltage to the security information management circuitry is cut off, identification information for identifying encryption information of the first key information and encryption information of the second key information based on the third key information,
wherein the first controller performs control to store in the third memory the generated identification information together with encryption information of the first key information and encryption information of the second key information, and
wherein the second controller generates, after a supply of the power supply voltage to the security information management circuitry is resumed, based on the third key information, identification information for identifying the encryption information of the first key information and the encryption information of the second key information stored in the third memory, determines whether the generated identification information matches with the identification information stored in the third memory, and, when the two identification information matches, performs control to store the first key information and the second key information in the first memory, the first key information and the second key information being obtained by decrypting, based on the third key information, encryption information of the first key information and encryption information of the second key information stored in the third memory.

11. The information processing system according to claim 10,
wherein after encrypting data based on the first key information, the second controller transmits the encrypted data and the identification information to the first controller, and
wherein the first controller transmits the encrypted data and the identification information to another information processing system via a network.

12. The information processing system according to claim 8,
wherein the security information management circuitry manages the first to the third key information so that the first key information and the second key information stored in the first memory and the third key information stored in the second memory is not output to an outside of the security information management circuitry.

13. The information processing system according to claim 8,
wherein the third memory is mounted in a nonvolatile memory device that is separated from a semiconductor device in which the security information management circuitry and the first controller are mounted, and
wherein, in addition to storing encryption information of the first key information and encryption information of the second key information, the nonvolatile memory device stores a program to be executed by the first controller.

14. The information processing system according to claim 8,
wherein The second memory stores the third key information based on at least one of an electrical fuse and a fixing of a logic of an input terminal of a logic circuit.

15. An information processing method to perform encryption processing and decryption processing of data to be transmitted and received by using at least one of a plurality of pieces of key information comprising:
storing first key information for encrypting data to be transmitted and received and a second key information for encrypting the first key information, into a volatile first memory in a security information management circuitry;
storing third key information for encrypting the first and second key information, into a non-volatile second memory in the security information management circuitry; and
storing, after a supply of the power supply voltage to the first memory is resumed, the first key information and the second key information obtained by decrypting encryption information of the first key information and encryption information of the second key information in the third memory based on the third key information, into the first memory.

16. The information processing method according to claim 15,
wherein before power supply voltage to the security information management circuitry is cut off, identification information for identifying encryption information of the first key information and encryption information of the second key information is generated based on the third key information,
wherein the generated identification information is stored in the third memory together with encryption information of the first key information and encryption information of the second key information, and
wherein after a supply of the power supply voltage to the security information management circuitry is resumed, identification information for identifying the encryption information of the first key information and the encryption information of the second key information stored in the third memory is generated based on the third key information, whether the generated identification information matches with the identification information stored in the third memory is determined, and when the two identification information matches, the first key information and the second key information being obtained by decrypting, based on the third key information, encryption information of the first key information and encryption information of the second key information stored in the third memory is stored in the first memory.

17. The information processing method according to claim 15,
wherein the security information management circuitry manages the first to the third key information so that the first key information and the second key information stored in the first memory and the third key information stored in the second memory is not output to an outside of the security information management circuitry.

18. The information processing method according to claim 15,
wherein the third memory is mounted in a nonvolatile memory device that is separated from a semiconductor device in which the security information management circuitry and the first controller are mounted, and
wherein, in addition to storing encryption information of the first key information and encryption information of the second key information, the nonvolatile memory device stores a program to be executed by the first controller.

19. The information processing method according to claim 15,
wherein the second memory stores the third key information based on at least one of an electrical fuse and a fixing of a logic of an input terminal of a logic circuit.
